(19) United States
(12) Patent Application Publication
(10) Pub. No.: US 2014/0045367 A1
(43) Pub. Date: Feb. 13, 2014

(54) BATTERY SYSTEMS FOR PERSON SUPPORT APPARATUS

(71) Applicant: Hill-Rom Services, Inc., Batesville, IN (US)

(72) Inventors: John D. Christie, Batesville, IN (US); Mahesh Kumar Thodupunuri, Batesville, IN (US); Keith Kubicek, Batesville, IN (US); Todd P. O'Neal, Fairfield, OH (US); Stan Garner, Greenfield, IN (US)

(21) Appl. No.: 13/957,692

(22) Filed: Aug. 2, 2013

Related U.S. Application Data
(60) Provisional application No. 61/680,426, filed on Aug. 7, 2012.

(51) Int. Cl. H01M 2/10

(52) U.S. Cl. CPC H01M 2/1022
USPC 439/500

(57) ABSTRACT

A system for removably mounting at least one battery on a person support apparatus is disclosed. Various latching mechanisms and locations for mounting are disclosed. A recharging station for recharging the battery is disclosed.

### BACKGROUND

Providing power to various systems on a person support apparatus has been an ongoing challenge particularly during transport of the stretcher or hospital bed. While several systems and methods of use exist for providing electrical power, opportunities exist for continued development in this area.

### BRIEF SUMMARY

The present disclosure includes one or more of the features recited in the appended claims and/or the following features which, alone or in any combination, may comprise patentable subject matter.

One embodiment of a system for removably retaining a battery holder on a person support apparatus may comprise a battery holder comprising a first electrical connector. A person support apparatus may comprise a second electrical connector wherein said battery holder may be configured to be removably mounted on the person support apparatus such that the first electrical connector may be electrically connected to the second electrical connector when the battery holder is mounted on the person support apparatus. A latch mechanism may be configured to removably retain the battery holder with respect to the person support apparatus.

One embodiment of a battery recharging system for a person support apparatus comprises a battery comprising at least one of a battery memory and a battery processor. A battery charging station may comprise at least one of a charging station memory and a charging station processor, said battery charging station may be configured to receive information from the battery.

Another embodiment of a battery recharging system for a person support apparatus may comprise a battery comprising at least one of a battery memory and a battery processor, a person support apparatus and means for locating the battery with respect to the person support apparatus.

### BRIEF DESCRIPTION OF DRAWINGS

The accompanying drawings incorporated in and forming a part of the specification illustrate several aspects of the claimed subject matter and, together with the description, serve to explain the principles of the claimed subject matter. In the drawings:

FIG. 1 is a perspective view of a person support apparatus, constructed according to one or more of the principles disclosed herein;

FIGS. 2A-2D are embodiments of battery holders for use with a person support apparatus, constructed according to one or more of the principles disclosed herein;

FIG. 3 is a perspective view of a person support apparatus showing one location of the battery holder, constructed according to one or more of the principles disclosed herein;

FIG. 4A is a front view of a battery holder, constructed according to one or more of the principles disclosed herein;

FIG. 4B is a top view of the battery holder shown in FIG. 4A configured to be removably mounted on a person support apparatus, constructed according to one or more of the principles disclosed herein;

FIG. 4C is a partial top view of the battery holder shown in FIG. 4A configured to be removably mounted by a push button and retaining pin on a person support apparatus, constructed according to one or more of the principles disclosed herein;

FIG. 5A is a front view of a battery holder, constructed according to one or more of the principles disclosed herein;

FIG. 5B is a side view of the battery holder shown in FIG. 5A configured to be removably mounted on a person support apparatus, constructed according to one or more of the principles disclosed herein;

FIG. 6A is a side view of a battery holder, constructed according to one or more of the principles disclosed herein;

FIG. 6B is a sectional side view of the battery holder shown in FIG. 6A configured to be removable mounted on a person support apparatus, construed according to one of more of the principles disclosed herein;

FIG. 7 is a perspective view of a person support apparatus showing one location of the battery holder, constructed according to one or more of the principles disclosed herein;

FIG. 8A is a front view of a battery holder, constructed according to one or more of the principles disclosed herein;

FIG. 8B is a sectional side view of the battery holder configured to be removable mounted on a person support apparatus, construed according to one of more of the principles disclosed herein;

FIG. 8C is another sectional side view of the battery holder configured to be removable mounted on a person support apparatus, construed according to one of more of the principles disclosed herein;

FIG. 9A is a top view of a battery holder, constructed according to one or more of the principles disclosed herein;

FIG. 9B is a front view of the battery holder configured to be removable mounted on a person support apparatus, construed according to one of more of the principles disclosed herein;

FIG. 9C is another sectional side view of the battery holder shown in FIG. 9B configured to be removable mounted on a person support apparatus, construed according to one of more of the principles disclosed herein;

FIG. 10A is a front view of a battery holder, constructed according to one or more of the principles disclosed herein;

FIG. 10B is a partial sectional side view of a latch mechanism to removably mount the battery holder shown in FIG. 10A on a person support apparatus, constructed according to one or more of the principles disclosed herein;

FIGS. 10C-10D show a cylindrical post feature to removably mount a battery holder on a person support apparatus, constructed according to one or more of the principles disclosed herein;

FIG. 11A is a front view of a battery holder, constructed according to one or more of the principles disclosed herein;

FIGS. 11B-11C show a slot feature to removably mount a battery holder on a stretcher and facilitate drainage, constructed according to one or more of the principles disclosed herein;

FIG. 12 is a front view of a battery holder showing a handle to carry the battery holder, constructed according to one or more of the principles disclosed herein;

FIG. 13 is a side view of a battery holder showing a latch to removably mount the battery holder shown in FIG. 12 on a person support apparatus and a catch feature to keep the battery from falling to the floor, constructed according to one or more of the principles disclosed herein;

FIG. 14 shows the installation of the battery holder shown in FIGS. 12 & 13 on a person support apparatus, constructed according to one or more of the principles disclosed herein;

FIG. 15 shows a push button feature to remove a battery holder from a person support apparatus, constructed according to one or more of the principles disclosed herein;

FIGS. 16A & 16B show a front and side view of a battery holder showing a handle to carry the battery holder, constructed according to one or more of the principles disclosed herein;

FIGS. 16C-16J show embodiments of battery holder release mechanisms configured to remove a battery holder mounted on a person support apparatus, constructed according to one or more of the principles disclosed herein;

FIGS. 17A-17D show another embodiment of a battery holder latching mechanism, constructed according to one or more of the principles disclosed herein;

FIG. 18 shows one embodiment of a person support apparatus with a charging unit and at least one battery, constructed according to one or more of the principles disclosed herein;

FIG. 19 shows one embodiment of a charging station configured to receive and replenish charge of at least one battery, constructed according to one or more of the principles disclosed herein;

FIGS. 20 & 21 show another embodiment of a battery holder latching mechanism, constructed according to one or more of the principles disclosed herein;

FIGS. 22 & 23 shows an embodiment of a battery holder latching mechanism and installation techniques, constructed according to one or more of the principles disclosed herein.

### DETAILED DESCRIPTION OF ILLUSTRATIVE EMBODIMENTS

The embodiments of the claimed subject mater and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be briefly mentioned or omitted so as to not unnecessarily obscure the embodiments of the claimed subject matter described. The examples used herein are intended merely to facilitate an understanding of ways in which the claimed subject matter may be practiced and to further enable those of skill in the art to practice the embodiments of the claimed subject matter described herein. Accordingly, the examples and embodiments herein are merely illustrative and should not be construed as limiting the scope of the claimed subject matter, which is defined solely by the appended claims and applicable law. Moreover, it is noted that like reference numerals represent similar parts throughout the several views of the drawings.

It is understood that the subject matter claimed is not limited to the particular methodology, protocols, devices, apparatus, materials, applications, etc., described herein, as these may vary. It is also to be understood that the terminology used herein is used for the purpose of describing particular embodiments only, and is not intended to limit the scope of the claimed subject matter.

Unless defined otherwise, all technical and scientific terms used herein have the same meanings as commonly understood by one of ordinary skill in the art.

The subject matter herein is directed towards a removable battery holder configured to contain batteries wherein the removable battery holder is mounted on a person support apparatus. Various latching mechanisms to locate the battery holder with respect to the person support apparatus are disclosed. In one embodiment a battery charging station is independent of the person support apparatus and the batteries contained by the battery holder are configured to be charged in the battery charging station. In another embodiment a charging unit is mounted on the person support apparatus and is configured to charge the batteries. The battery holder and/or the batteries are configured to be used interchangeably with various person support apparatus such as patient lifts, stretchers and hospital beds.

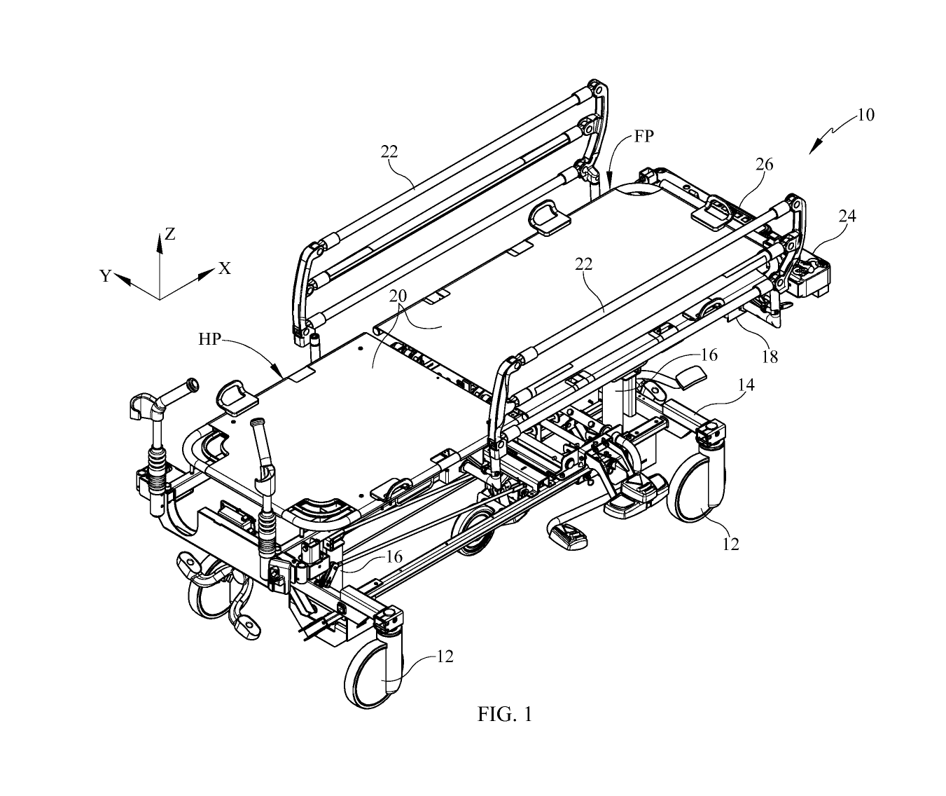

FIG. 1 shows one embodiment of a person support apparatus/stretcher 10. In another embodiment the person support apparatus is a hospital bed, while in yet another embodiment the person support apparatus may be a patient lift or any type of furniture. The stretcher 10 comprises a lower frame 14 supported by dedicated wheels 12 which rests on a supporting surface, typically the floor of a hospital room. Upper frame 18 is supported by the supports 16 over the lower frame 14 and is configured to be variably articulated in relation to the lower frame 14. Upper frame 18 comprises deck sections 20 to support the upper and lower body of a person supported by the person support apparatus 10. The deck sections 20 allow placement of a mattress over them, upon which a person is typically supported. Siderails 22 on either side of the stretcher 10 define the lateral extremities of the stretcher 10 when the siderails 22 are deployed in their highest vertical position with respect to the floor. The person support apparatus 10 comprises a head support portion or head end HP and a foot support portion or foot end FP. In the embodiment shown in FIG. 1 the person support apparatus 10 comprises a housing/shroud 24 which houses a control interface 26. Control interface 26 allows a user to control at least one function of the person support apparatus 10. A frame of reference is shown in FIG. 1 wherein X axis substantially aligns with the length and the Y axis substantially aligns with the width of the person support apparatus 10. The Z axis is orthogonal to the X and Y axis as shown in FIG.1.

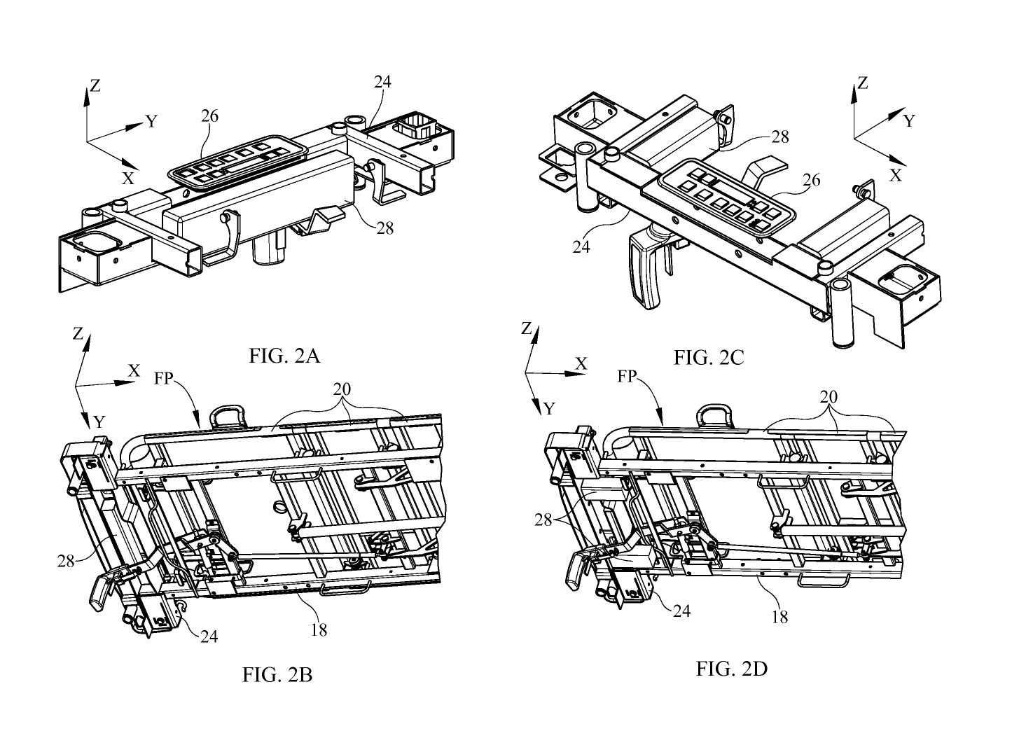

As shown in FIG. 2A & FIG. 2B, one embodiment of a battery holder or battery pack 28 comprises 2 rows of 4 batteries in-line for a total of 8 batteries. In the embodiments shown in FIGS. 2A & 2B, the length of the battery holder 28 substantially aligns with axis Y. In the embodiment shown in FIG. 2A, the battery holder 28 is configured to be mounted to the upper frame 18. In the embodiment shown in FIG. 2B, the battery holder 28 is configured to be mounted to the housing 24. As shown in FIGS. 2C & 2D another embodiment of the battery holder 28 comprises 2 levels of 4 cells wherein the battery holder 28 is mounted to the upper frame 18. In the embodiments shown in FIG. 2C & 2D, the length of the battery holder 28 substantially aligns with axis Y. In other embodiments the battery holder 28 is configured to hold any number of batteries. In yet another embodiment, the battery holder 28 is mounted to any portion of the person support apparatus 10 including but not limited to the lower frame 14, deck sections 20, side rails 22 and/or head or foot boards (not shown).

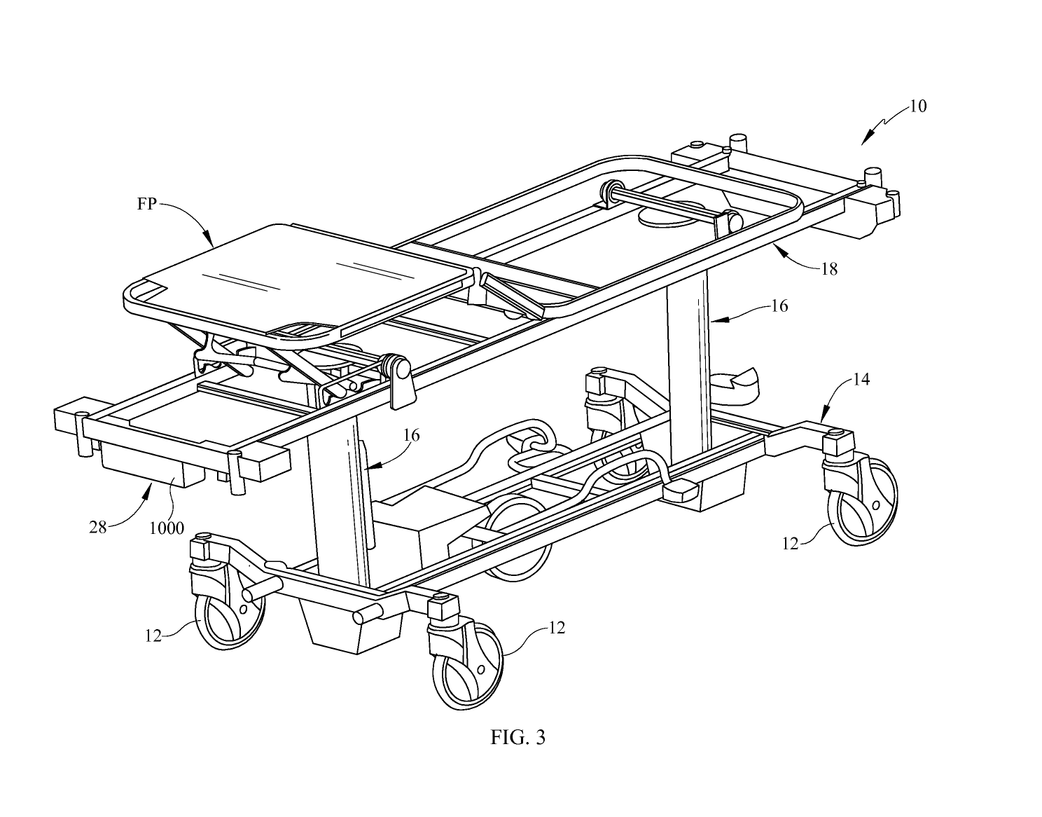

FIG. 3 shows one embodiment of a battery holder 28 mounted to the foot end of the person support apparatus 10. The outside or footward-most face 1000 of the battery pack is approximately flush with the shroud.

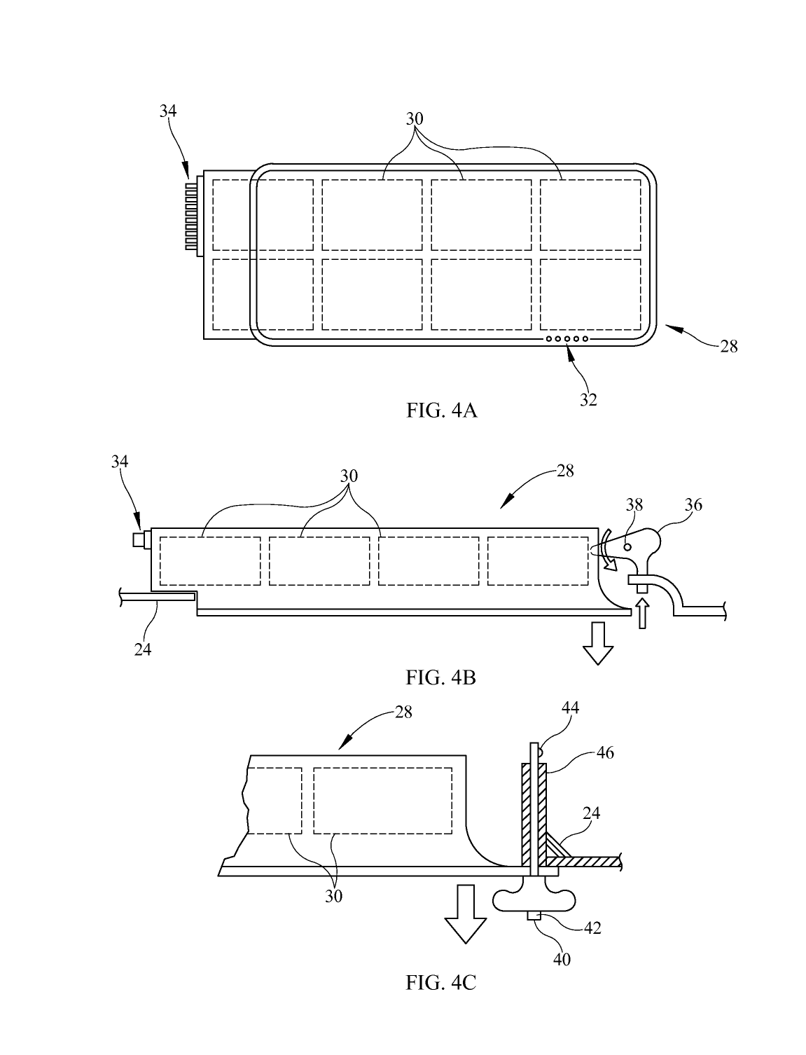

FIG. 4A is a front view of one embodiment of a battery holder 28 configured to house batteries or cells 30. The battery holder comprises a fuel gauge display 32. The fuel gauge display 32 in this embodiment comprises LEDs which are variably illuminable to indicate the level of charge of the batteries 30 in the battery holder 28. In this embodiment, the lower the number of LEDs lit, the lower the charge of the batteries 30 in the battery holder 28. In other embodiments the fuel gauge display 32 may comprise a single LED which may be configured to be illuminated or turned off if the charge of the batteries 30 contained by the battery holder 28 falls below a predetermined level. The battery holder comprises an electrical connector 34 configured to mate with an electrical connector in the housing 24. FIG. 4B shows a top view of one embodiment of a battery holder 28. As shown in FIG. 4B a portion of the housing/shroud 24 is configured to capture the battery holder 28. A latch 36 is configured to pivot about a latch pivot 38 and engage a portion of the battery holder 28 so as to locate the battery holder. The latch 36 in the embodiment shown in FIG. 4B is spring loaded and is configured to be disengaged from the battery holder 28 by a user upon application of force on a push button 42 to overcome the spring force. In another embodiment the push button 42 comprises a detent mechanism configured to provide a force to be overcome for actuation of the push button 42. FIG. 4C shows a partial top view of yet another embodiment of a battery holder 28 showing another latching mechanism to removably locate the battery holder 28 with respect to the housing/shroud 24. The embodiment shown in FIG. 4C comprises a retaining pin 44 configured to engage a housing retainer 46. A push button 42 allows a user to engage or disengage the retaining pin 44 from the housing retainer 46. The push button 42 is spring loaded in one embodiment, in another embodiment the push button 42 comprises a detent mechanism configured to provide a force to be overcome for actuation of the push button 42.

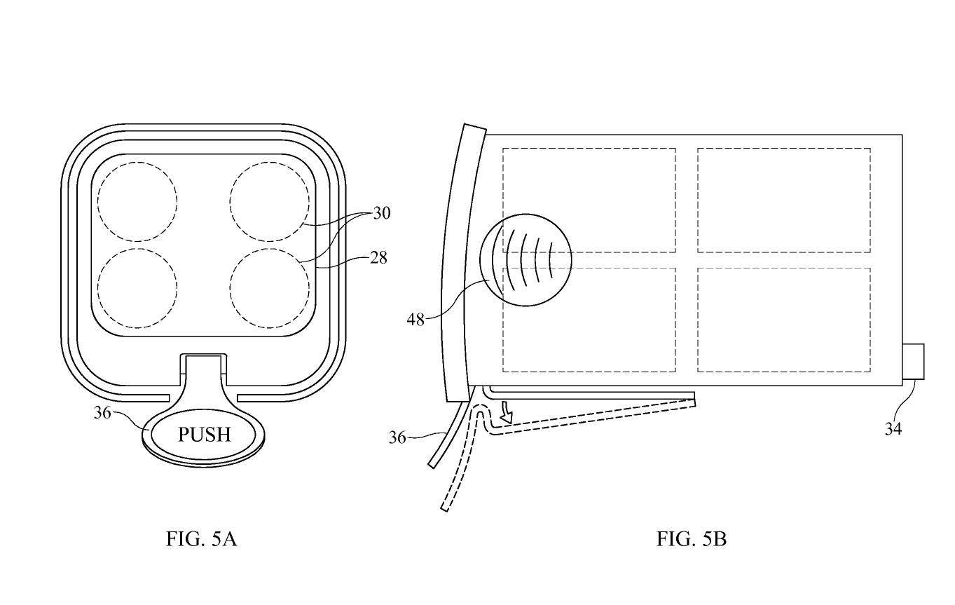

FIGS. 5A & 5B are front and side views respectively of another latching mechanism to locate a battery holder 28 with respect to the person support apparatus 10. As shown in FIG. 5A the battery holder 28 is configured to slide into a housing 24 on the person support apparatus 10. As shown in FIG. 5B the battery holder 28 comprises finger grips 48 on each side to allow a user to grip the battery holder 28. A latch 36 is part of the person support apparatus 10 in this embodiment, the latch 36 comprising an area for the user to push as shown in FIG. 5A. The latch 36 is configured to retain the battery holder 28 in the equilibrium position as shown in FIGS. 5A and 5B. To remove the battery holder 28 a user elastically deforms the latch 36 such that the latch 36 is released to a disengaged position shown by dotted lines in FIG. 5B. A user may then remove the battery holder 28 using finger grips 48. Upon release, the latch 36 is configured to return to the equilibrium position.

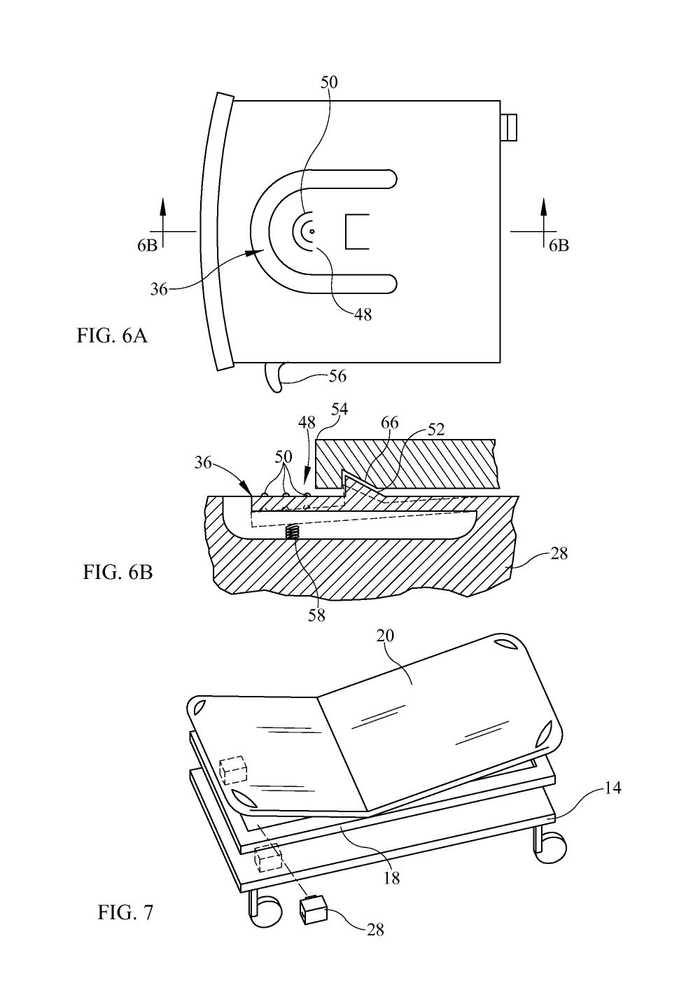

FIGS. 6A & 6B are side and sectional views of another latching mechanism to latch a battery holder 28 with a person support apparatus 10. As shown in FIG. 6B the battery holder 28 comprises a latch 36. The latch 36 comprises ribs 50 on finger grips 48 and a latch engagement feature 52. In the equilibrium position the latch engagement feature 52 is configured to engage a notch 66 on the person support apparatus battery retaining feature 54, latching the battery holder 28 with respect to the person support apparatus 10. The battery holder 28 is configured to disengage from the person support apparatus 10 when a user elastically deforms the latch 36 to disengage the engagement feature 52 from the notch 66. A battery removal aid 56 in the form of an extrusion in this embodiment is provided to allow the user to dismount the battery holder 28 from the person support apparatus 10, in another embodiment the battery removal aid 56 may be in the form of a slot. A latch return spring 58 in this embodiment is configured to bias the latch 36 to return to the equilibrium position. FIG. 7 shows one location of placement of the battery holder 28 on the person support apparatus 10. As shown in FIG. 7 the battery holder 28 is positioned towards the head end of the person support apparatus. In other embodiments more than one battery holders 28 are used.

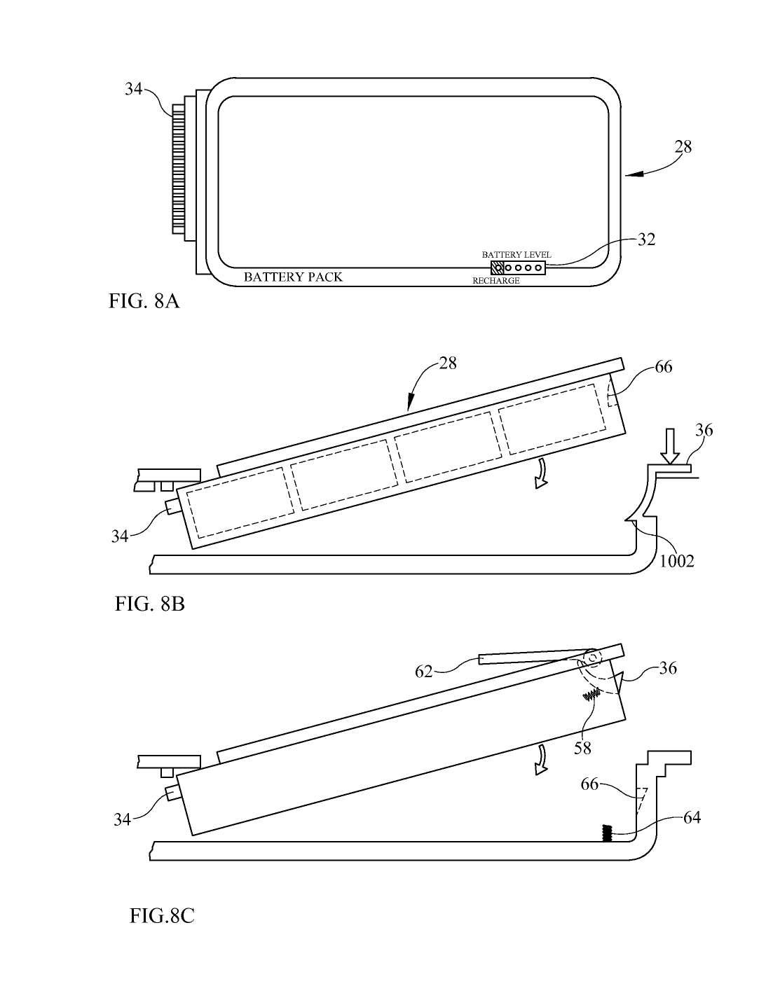

FIG. 8A is a front view of a battery holder 28 showing connector 34 and battery power indicator 32. FIG. 8B is a side view of showing one embodiment of a latching mechanism to secure the battery holder 28 with respect to the person support apparatus 10. The battery holder 28 in this embodiment comprises a notch 66 which is configured to capture a portion of the latch 36. During installation of the battery holder 28 onto the person support apparatus 10 the battery holder 28 is configured to slide under a portion of the housing/shroud 28 at one end. Connector 34 on the battery holder 28 mates with corresponding connector 34A on the person support apparatus 10. The latch 36 is configured to be elastically deformed by a user allowing the battery holder 28 to be positioned such that the notch 66 aligns with a retaining feature 1002 in the latch 36. The user would then release the latch 36 such that the retaining feature of the latch 36 would engage the notch 66. In another embodiment during mounting of the battery holder 28, force application by the user on the battery holder would elastically deform the latch 36 and align the retaining feature with the notch 66. To remove the battery holder 28, the latch 36 is elastically deformed to disengage the retaining feature from the notch 66. FIG. 8C shows another embodiment of a latching mechanism wherein the person support apparatus has a notch 66 configured to receive an engagement feature of the latch 36. In the embodiment shown in FIG. 8C the latch 36 has a latch return spring 58 to bias the latch 36 to engage the notch 66. In one embodiment a lever 62 allows a user to act against the spring force of the latch return spring 58. To mount the battery holder 28 on the person support apparatus 10 the user in one embodiment applies a force on the battery holder to act against the spring force such that the latch 36 compresses latch return spring 58 before it finds the notch 66. To dismount the battery holder 28 from the person support apparatus 10, a user would actuate the lever 62 to act against the spring force of the latch return spring 58 and disengage the latch 36 from the notch 66. Lever 62 is also configured to remove the battery holder 28 from the person support apparatus in this embodiment. As shown in FIG. 8C a battery ejection spring 64 provides spring force in a direction assisting ejection of the battery holder 28 from the person support apparatus 10.

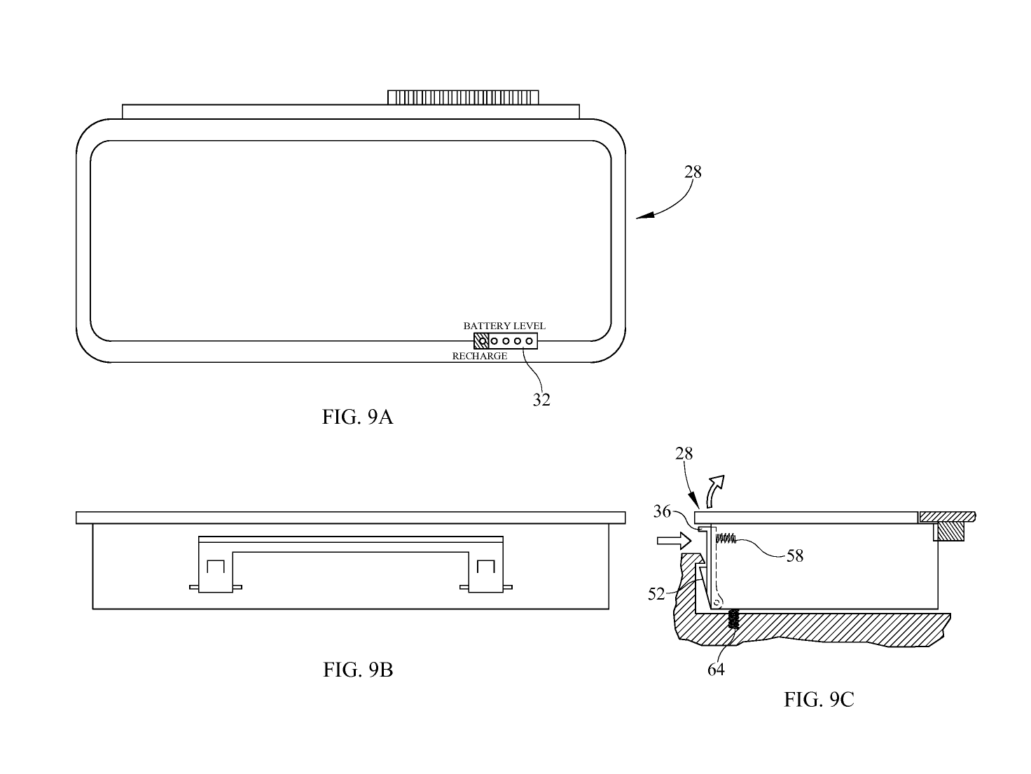

FIGS. 9A, 9B and 9C show another embodiment of a latching mechanism to secure the battery holder 28 with respect to the person support apparatus 10. FIG. 9A and 9B are the front and top views respectively, FIG. 9C shows a sectional side view of a battery holder 28 located with respect to a person support apparatus 10. As shown in FIG. 9C the latch 36 comprises a latch engagement feature 52 which engages a portion of the person support apparatus 10. The latch 36 is spring loaded and the latch return spring 58 is configured to apply a spring force such that the equilibrium position of the latch 36 is to engage the person support apparatus 10. To dismount a battery holder 28 from a person support apparatus 10, a user applies force on the latch 36 against the latch return spring 58 and disengages the latch from the person support apparatus 10. The battery holder 28 may then be lifted out of the recess as shown in FIG. 9C. A battery ejection spring 64 allows for an aiding spring force during extraction of the battery holder 28.

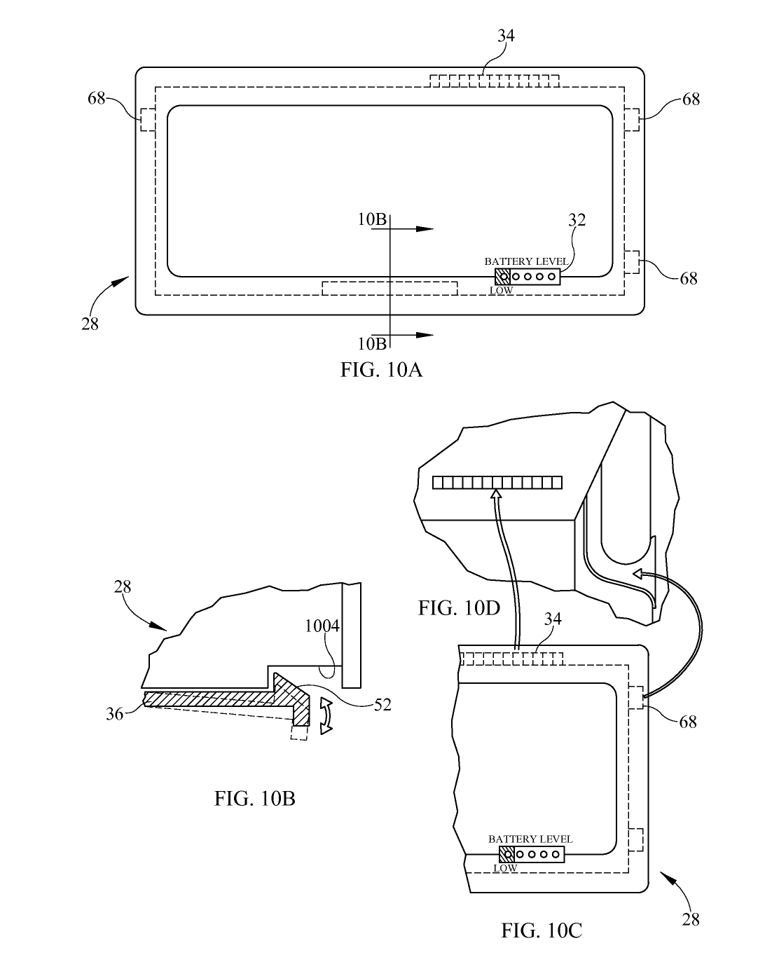

FIG. 10A shows a battery holder latching and guide mechanism with at least one guide feature 68 to aid in installation of the battery holder 28 with respect to the person support apparatus 10. As shown in FIG. 10A the battery holder 28 has one guide feature 68 on each side in one embodiment, while in other embodiments the battery holder 28 may have any number of guides 68. In this embodiment the guide feature 68 on the battery holder 28 is a cylindrical post configured to engage a slot in the person support apparatus as shown in FIGS. 10C & 10D. In another embodiment the guide feature 68 may be of any shape while in yet another embodiment the slot is incorporated into the battery holder 28 and the guide feature 68 to engage the slot is incorporated into the person support apparatus 10. FIG. 10B shows a partial cross-sectional view of a latch 36 engaging an indent 1004 in the battery holder 28. The latch 36 is a portion of the person support apparatus 10 in this embodiment. In the equilibrium position a latch engagement feature 52 of the latch 36 is configured to engage the indent in the battery holder 28 if the battery holder 28 is mounted on the person support apparatus 10. A user may disengage the latch 36 from the indent as shown in FIG. 10B and dismount the battery holder 28 from the person support apparatus 10 by applying force on the battery holder 28 such that the guide feature 68 is removed from its slot.

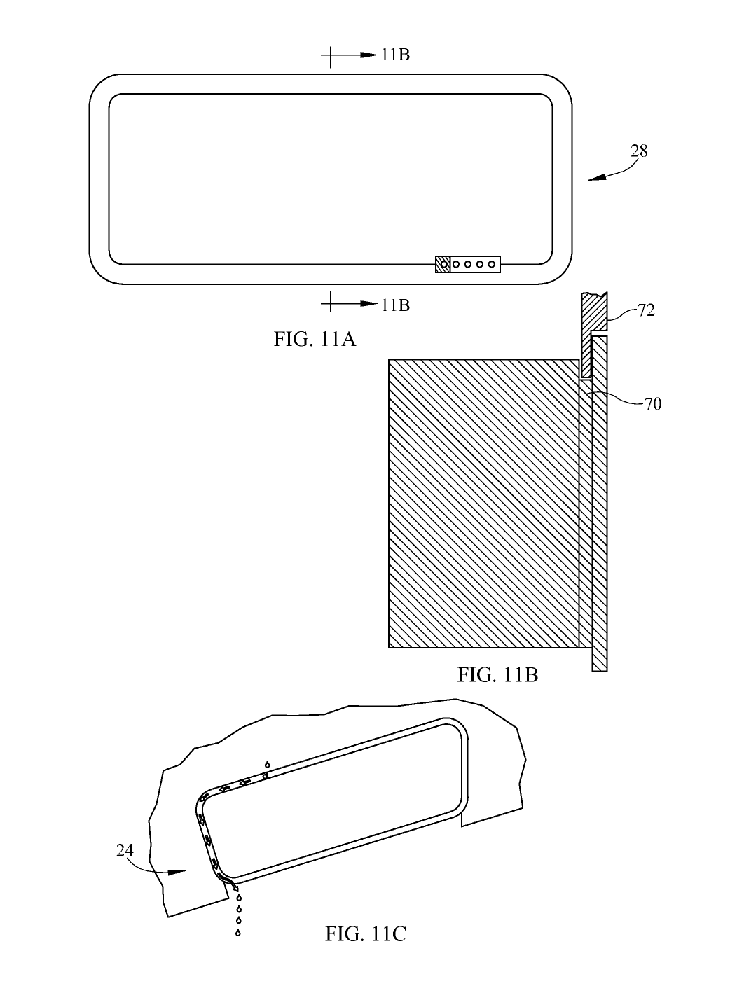

FIG. 11B is a cross-sectional view of FIG. 11A depicting a battery holder 28 configured to be located with respect to a person support apparatus 10, the battery holder 28 comprises a slot 70 which runs across the circumference of at least a portion of the battery holder 28. A tab feature 72 is a portion of the person support apparatus 10 and configured to engage the slot 70. The slot 70 in the battery holder 28 allows for water and/or other fluids to be directed along the channel formed by the slot to be drained away as shown in FIG. 11C. The slot 70 therefore allows for drainage of any fluids that the interface may be exposed to during cleaning, maintenance, use and/or transport.

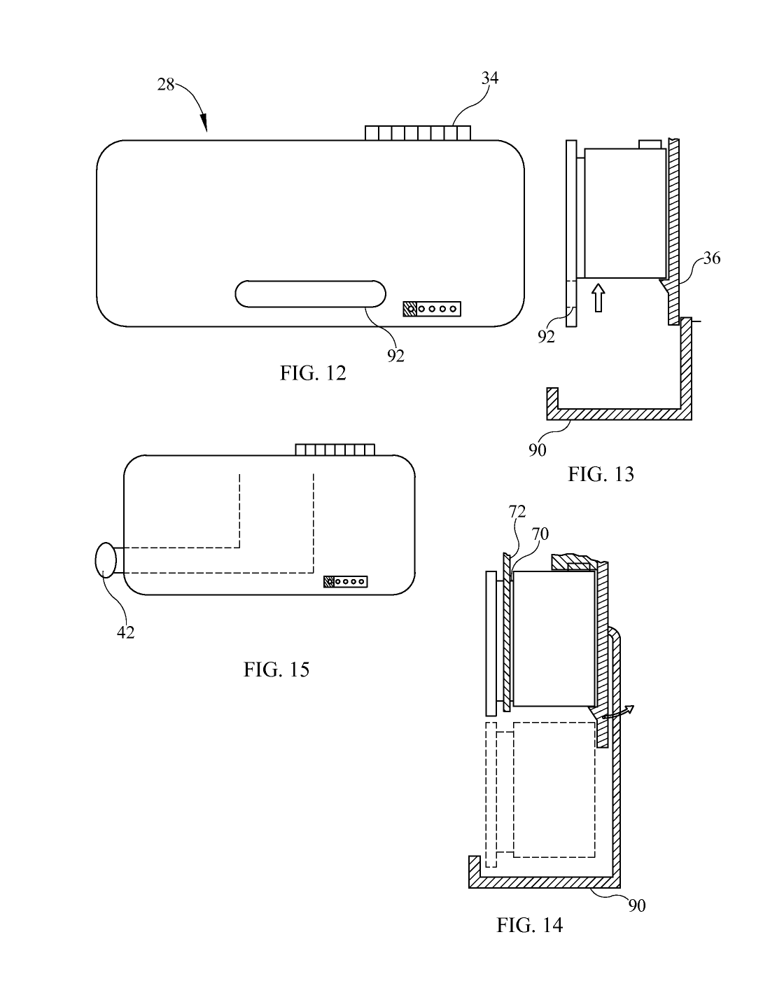

FIG. 12 shows one embodiment of a battery holder 28 comprising a handle 92 to aid in installation, removal and transport. In another embodiment shown in FIG. 13 the person support apparatus 10 comprises a latch 36 which snaps over the bottom edge of the battery holder 28 in this embodiment. The person support apparatus 10 also comprises a catch feature 90 which serves to capture the battery holder 28 in case it comes free of the latch 36 during use and/or transport. FIG. 14 shows the installation process wherein the battery holder 28 comprises a slot 70 which is engaged by a tab feature 72. The latch 36 is configured to be elastically deformed during insertion and removal of the battery holder 28 and is configured to snap under the battery holder 28 as shown in FIG. 14. FIG. 15 shows a push button 42 configured to extend off the latch 36 in FIGS. 13 & 14 such that a user may press the push button to elastically deform the latch 36 and allow for un latching of the battery holder 28 with respect to the person support apparatus 10. In the embodiment shown in FIG. 15, a user has the opportunity to actuate the push button 42 instead of reaching into catch feature 90 to apply force on the latch 36.

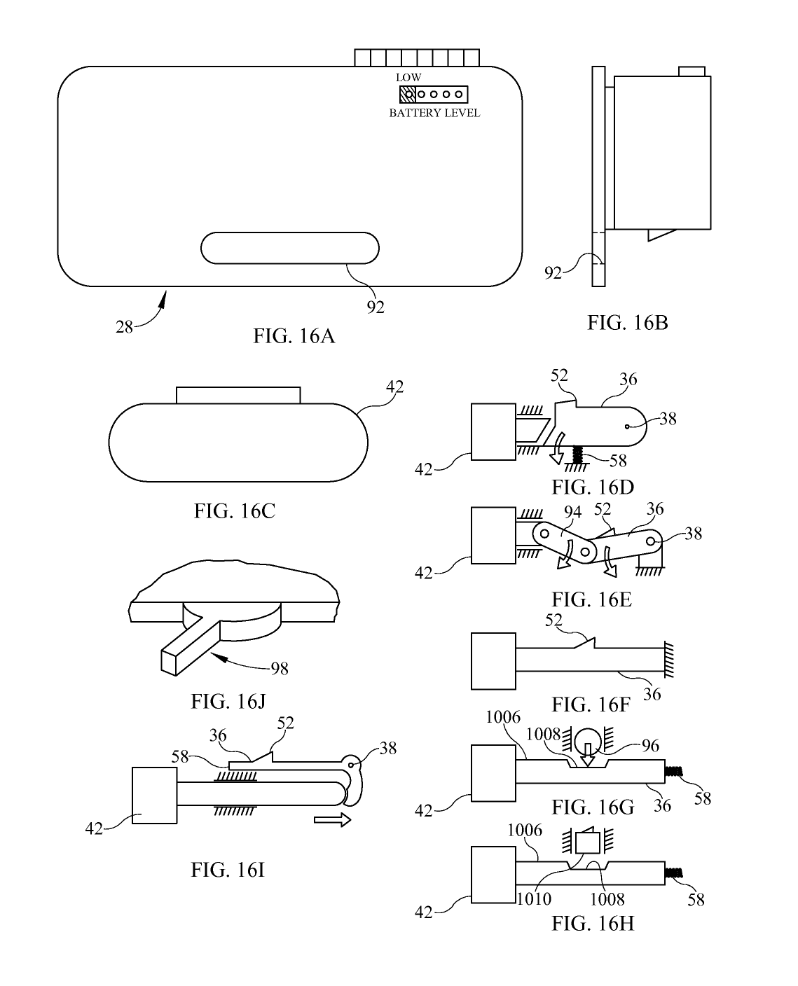

FIGS. 16A & 16B show a front and side view respectively of a battery holder 28 showing a handle 92 to carry the battery holder 28. FIG. 16C shows a front view of a push button 42 which is used to latch and/or unlatch the battery holder 28 from the person support apparatus 10. FIG. 16D shows one embodiment of a latch mechanism wherein application of force on the pushbutton 42 is transmitted to a latch 36 which rotates about a latch pivot 38. As the latch 36 rotates about the latch pivot 38, a latch engagement feature 52 on the latch 36 rotates as well and therefore is configured to be used to unlatch and/or latch the battery holder 28 with respect to the person support apparatus 10. A latch return spring 58 is configured to return the latch 28 to an equilibrium position. FIG. 16E shows another embodiment of a latching mechanism wherein actuation of the push button 42 causes a translation and rotation of the latch linkage 94 as shown in FIG. 16E, the latch linkage 94 transmits force applied on the push button 42 to the latch 36. Latch 36 is configured to rotate about a latch pivot 38 such that the latch engagement feature rotates as well. A latch return spring 58 (not shown) is incorporated into the latch pivot 38 in this embodiment and returns the latch mechanism shown in FIG. 16E to the equilibrium position when force from the push button 42 is removed. FIG. 16F shows another embodiment of a latching mechanism wherein the latch 36 is configured to be deformed elastically by a user by application of force causing motion of the latch engagement feature 52. FIG. 16G shows another latch mechanism wherein a ball 96 functions as a latch in the equilibrium state. The ball 96 serves as the latch engagement feature in one embodiment and sits on a flat surface 1006 of the latch 36 in equilibrium. As the push button 42 is pressed the latch moves, aligning a notch 1008 on the latch 36 with the ball 96 causing the ball to drop into the notch thereby allowing unlatching. When the push button 42 is released, a latch return spring 58 applies a spring force which is transmitted to the ball 96 and the ball 96 rides up angled sides of the notch in the latch 36 and between the sidewalls to a latched position. FIG. 16H shows an alternate embodiment of the latching mechanism shown in FIG. 16G wherein a polygonal shaped block 1010 is used instead of the ball 96. FIG. 16I shows another embodiment of a latching mechanism wherein actuation of the push button 42 causes rotation of the latch 36 about latch pivot 38 thereby causing motion of the latch engagement feature 52 which is used to unlatch the battery holder 28 form the person support apparatus 10. A latch return spring 58 provides spring force and returns the latch 36 to the equilibrium position once force is removed from the push button 42. FIG. 16J shows one embodiment of a cam type level latch 98 which may be used instead of a pushbutton to engage and/or disengage the battery holder 28 from the person support apparatus 10.

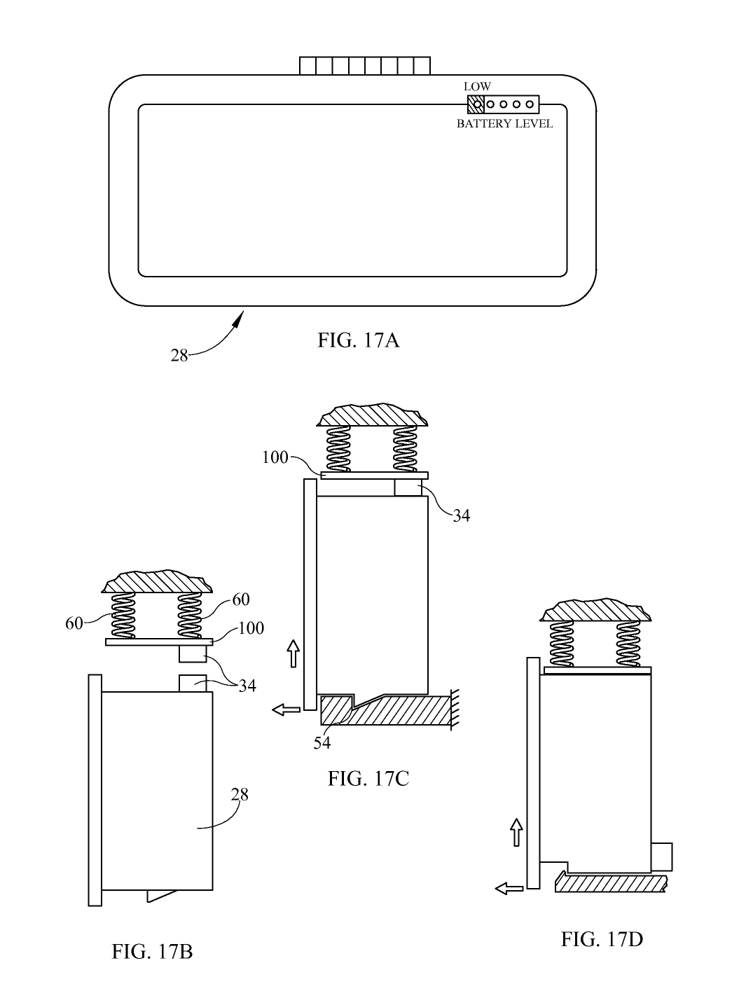

FIGS. 17A, 17B, 17C & 17D show another embodiment of a latching mechanism to locate a battery holder 28 with respect to a person support apparatus 10. FIG. 17A shows a front view of a battery holder 28. FIGS. 17B, 17C and 17D show a circuit board 100 suspended by at least one preload spring 60 which in turn is connected to the person support apparatus (not shown). The preload springs 60 shown in the figures are configured to apply a spring force on a battery holder 28 placed between the circuit board 100 and the person support apparatus 10. A person support apparatus battery retaining feature 54 is configured to capture a portion of the battery holder 28 as shown in FIG. 17C. The circuit board 100 comprises a connector 34 which mates with a connector 34 on the battery holder 28 when the battery holder 28 is installed. A user would apply force to oppose spring force applied by the preload springs 60 allowing the battery holder 28 to be dismounted (FIG. 17D).

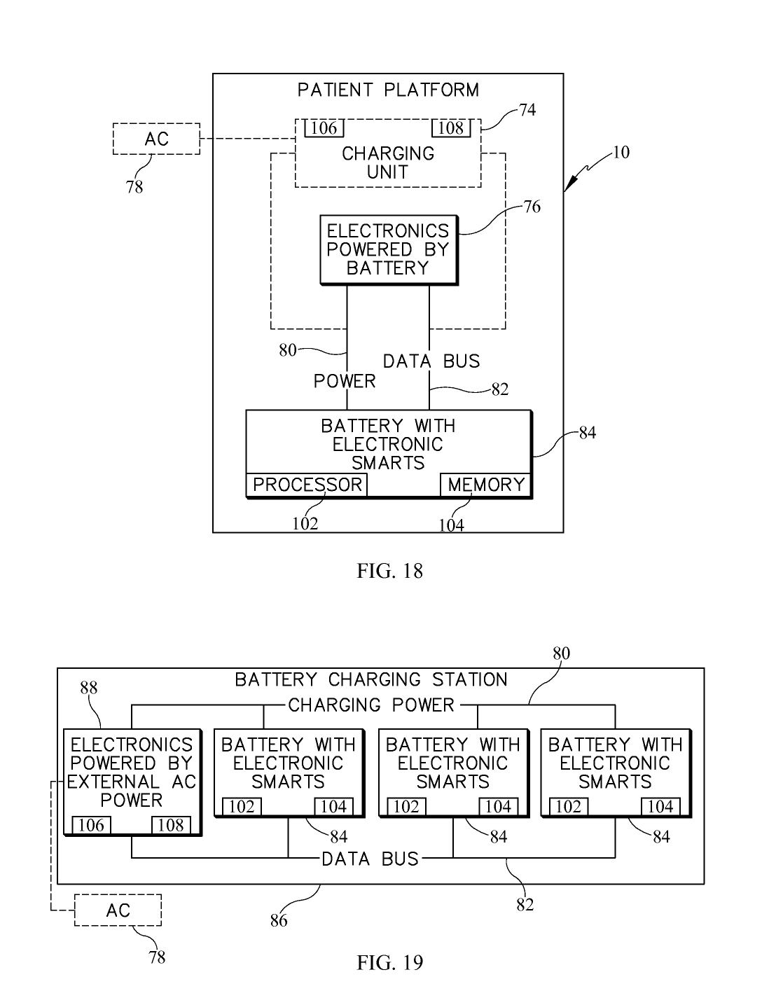

FIG. 18 shows one embodiment of a battery recharging system wherein a battery 84 is mounted on a person support apparatus 10. The battery 84 comprises at least one battery processor 102 and at least one battery memory 104 in this embodiment. In another embodiment the battery 84 may comprise only the battery processor 102 or the battery memory 104. The battery processor 102 is configured to communicate with electronics and/or electrical device 76 by way of power line 80 and data bus 82. The power line 80 is configured to provide electrical power to the electronics and/or electrical device 76 while the data bus 82 is configured to communicate information. In the embodiment shown in FIG. 18, a charging unit 74 is mounted on the person support apparatus 10. The charging unit 74 comprises a charging station processor 106 and a charging station memory 108. In another embodiment the charging unit 74 may comprise only the charging unit processor 106 or the charging unit memory 108. The charging unit 74 is configured to be removably connected to the battery 84 by the power line 80 and the data bus 82 as shown by the dotted lines. The battery 84 is configured to transmit any one of charge level of battery, temperature history, cycle count, manufacture date, charging requirements including charging profile and/or voltage and/or current, user pattern, maintenance requirements, identification number, battery type, serial number and manufacturer's name to the charging unit 74. The charging unit 74 is connected to power source 78 and in this embodiment the charging unit 74 is configured to transform alternating current supplied by power source 78 into direct current with which the charging unit 74 is configured to charge the battery 84. The battery 84 in this embodiment is a Lithium Ion type battery, in other embodiments battery 84 may be of any type.

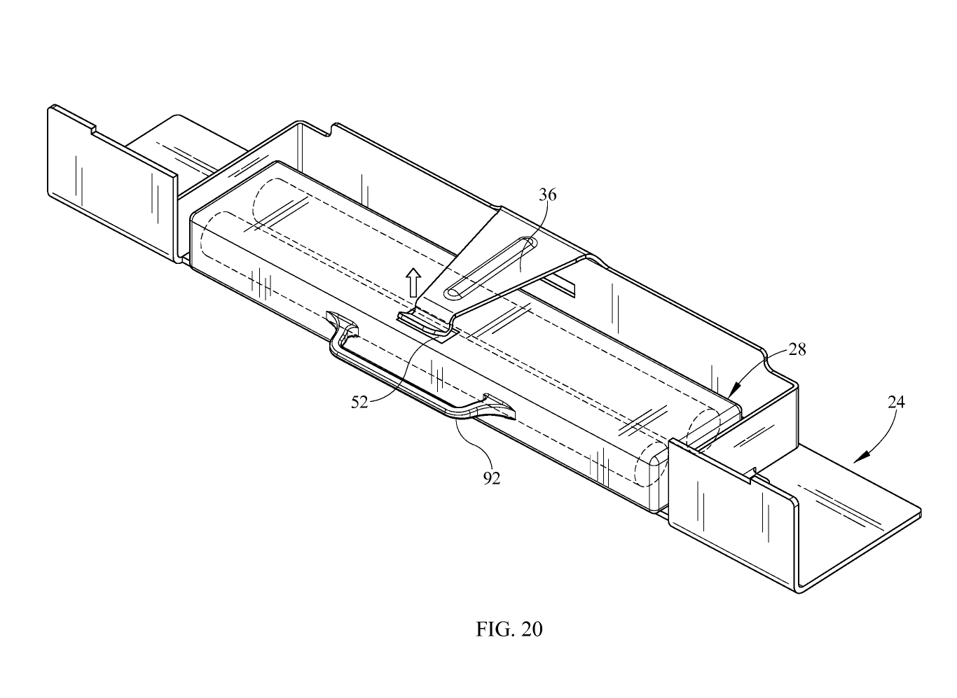

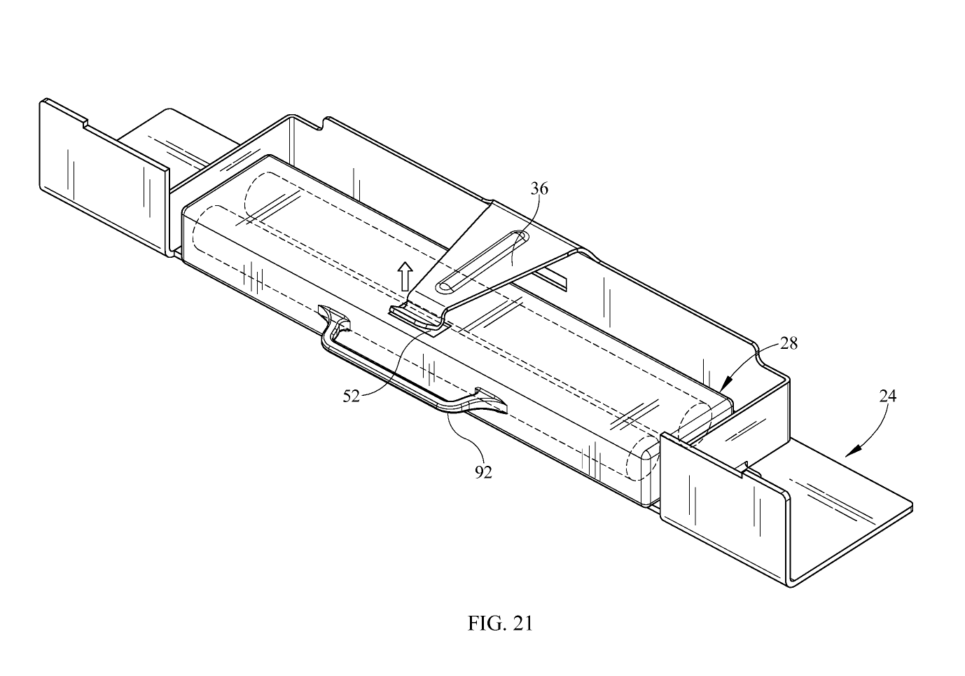

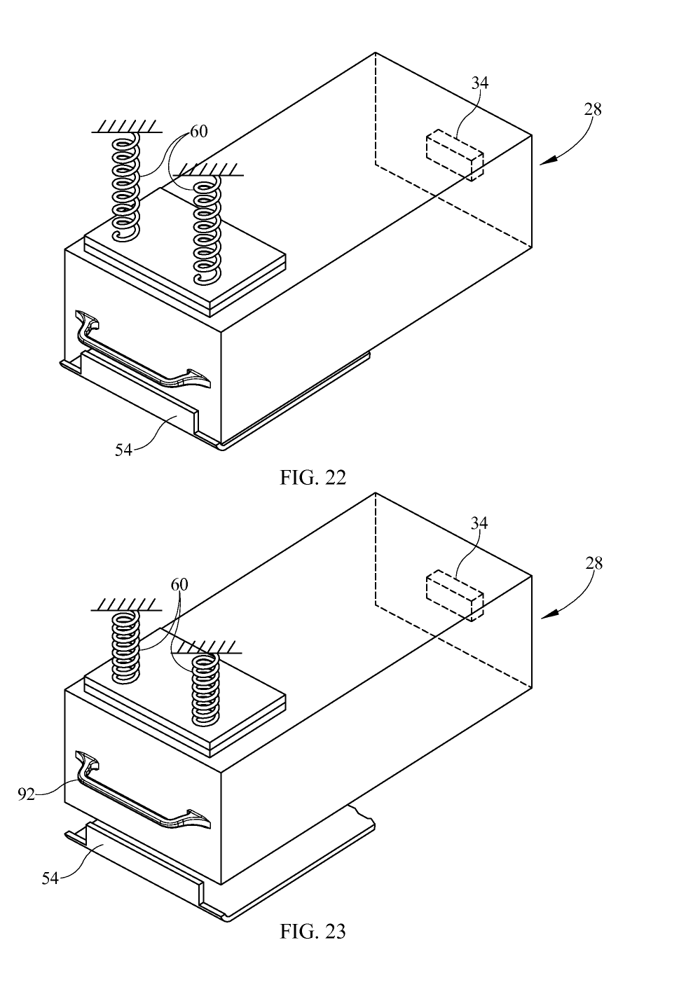

In another embodiment of a battery recharging system shown in FIG. 19, the battery 84 is configured to be removed from the person support apparatus 10 and charged on a stand-alone battery charging station 86. The battery charging station 86 comprises a charging station circuit board 88, the charging station circuit board 88 comprising a charging station processor 106 and a charging station memory 108. FIG. 19 shows the battery charging station 86 configured to charge multiple batteries at the same time. The battery 84 is configured to transmit any one of charge level of battery, temperature history, cycle count, manufacture date, charging requirements including charging profile and/or voltage and/or current, user pattern, maintenance requirements, identification number, battery type, serial number and manufacturer's name to the charging station circuit board 88. The charging station circuit board 88 is connected to power source 78 and in this embodiment the charging station circuit board 88 is configured to transform alternating current supplied by power source 78 into direct current with which the charging station circuit board 88 is configured to charge the battery 84. The battery 84 in this embodiment is a Lithium Ion type battery, in other embodiments battery 84 may be of any type. In one embodiment the battery 84 is configured to be used with more than one person support apparatus 10 interchangeably including but not limited to stretchers, hospital beds and patient lift systems.

FIGS. 20 & 21 show another embodiment of a battery holder 28 latching mechanism wherein the battery holder 28 is configured to be mounted on a housing/shroud 24 of a person support apparatus. The battery holder 28 comprises a handle 92 which allows a user to grip the battery holder 28 during installation, removal and transport. The housing/shroud 24 comprises a latch 36 which is cantilevered at one end while the other end comprises a latch engagement feature 52 and is configured to engage the battery holder 28 when the battery holder 28 is mounted on the person support apparatus 10. In the embodiment shown in FIG. 20 the battery holder 28 is mounted or removed from the housing/shroud 24 by applying force on the handle 92 which elastically deforms latch 36 allowing for installation or removal of the battery holder 28. In the embodiment shown in FIG. 21 force is applied by a user on the cantilevered end of the latch 36 to elastically deform it by lifting it such that the battery holder 28 is then accessible to for removal.

FIGS. 22 & 23 show another embodiment of a battery holder 28 latching mechanism wherein the person support apparatus comprises a person support apparatus battery retaining feature 54 which is configured to restrict the degrees of motion available to the battery holder 28 to move with respect to the person support apparatus 10 once the battery holder 28 is mounted. At least one preload spring 60 is configured to apply a spring force on the battery holder 28 to limit motion of the battery holder 28 once mounted. The battery holder latching mechanism shown in FIGS. 22 & 23 is configured to allow a user to apply force against the spring force to lift the battery holder 28 out of engagement with the person support apparatus battery retaining feature 54.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

The disclosures of any references and publications cited above are expressly incorporated by reference in their entireties to the same extent as if each were incorporated by reference individually.

We claim:

1. A system for removably retaining a battery holder on a person support apparatus, comprising:
a battery holder comprising a first electrical connector;
a person support apparatus comprising a second electrical connector wherein said battery holder is configured to be removably mounted on said person support apparatus such that said first electrical connector is electrically connected to said second electrical connector when said battery holder is mounted on said person support apparatus; and
a latch mechanism configured to removably retain said battery holder with respect to said person support apparatus.

2. The system of claim 1 wherein said latch mechanism comprises a latch engagement feature.

3. The system of claim 1 wherein said latch engagement feature is part of said battery holder.

4. The system of claim 1 wherein said latch engagement feature is part of said person support apparatus.

5. The system of claim 1 wherein said latch engagement mechanism comprises at least one structure configured to elastically deform during use of said latch mechanism.

6. The system of claim 1 wherein said latch engagement mechanism comprises a pushbutton, upon actuation of which said battery holder is removable from said person support apparatus.

7. The system of claim 1 wherein said latch engagement mechanism comprises a latch return spring, configured such that a user would act against force applied by said latch return spring to unlatch said battery holder with respect to said person support apparatus.

8. The system of claim 1 wherein said battery holder comprises a guide feature configured to mate with said person support apparatus.

9. The system of claim 1 wherein said battery holder comprises a slot feature configured to allow drainage of water along said slot feature.

10. The system of claim 1 further comprising a catch feature configured to retain said battery holder if said battery holder dis-engages from said person support apparatus.

11. The system of claim 1 wherein said latching mechanism further comprises a circuit board configured to be powered by said battery holder when said first electrical connector is electrically connected to said second electrical connector.

12. The system of claim 1 wherein said person support apparatus further comprises a housing to locate said battery holder.

13. The system of claim 1 wherein said housing comprises a shroud feature to retain said battery holder.
